(19) United States
(12) Patent Application Publication
(10) Pub. No.: US 2015/0358838 A1
(43) Pub. Date: Dec. 10, 2015

(54) BUFFER STATUS REPORTING FOR DUAL CONNECTION

(71) Applicants: Na WEI, Beijing (CN); Wei BAI, (US); Xinying GAO, (US); Haiming WANG, (US); Lili ZHANG, (US); Pengfei SUN, (US); Jing HAN, (US)

(72) Inventors: Na WEI, Beijing (CN); Wei BAI, Beijing (CN); Xinying GAO, Beijing (CN); Haiming WANG, Beijing (CN); Lili ZHANG, Beijing (CN); Pengfei SUN, Beijing (CN); Jing HAN, Beijing (CN)

(21) Appl. No.: 14/759,881

(22) PCT Filed: Jan. 18, 2013
(86) PCT No.: PCT/CN2013/070650

§ 371 Date: Jul. 8, 2015

(30) Foreign Application Priority Data
Jan. 10, 2013 (CN) PCT/CN2013/070314

(51) Int. Cl. H04W 24/04; H04W 72/10; H04W 76/02; H04W 28/02

(52) U.S. Cl. CPC H04W 24/04; H04W 28/0278; H04W 72/10; H04W 76/025

(57) ABSTRACT

Apparatus, methods, and computer programs that selectively transmit one or more local area buffer status reports by a macro base station over a macro link or transmit a macro buffer status report by a local area access point over a local area link in a dual connection deployment scenario in response to a cross link buffer status report trigger. The apparatus, methods and computer programs may include several cross buffer status reporting triggers. The user equipment may trigger cross buffer status reporting in response or incidental to one or more measurement events. The user equipment may also trigger cross buffer status reporting in response to or incidental to a link failure. The user equipment may also trigger cross buffer status reporting in response to receiving a request from an eNB.

### FIELD OF THE INVENTION

The example and non-limiting embodiments of the invention relate generally to wireless communication systems, methods, devices and computer programs, and, more specifically, relate to buffer status reporting among user equipment and access points in a dual connection scenario in a long term evolution network.

### BACKGROUND

Increasingly, the vast majority of voice and data traffic over wireless telecommunication networks is occurring indoors, such as in residential homes, offices, schools, retail stores, commercial and governmental buildings, as well other institutions and public transportation systems. Much of the data traffic is handled by so-called hotspots, which are small wireless access areas that provide wireless Internet access through WiFi enabled wireless local area networks (WLANs). Radio access technologies (RATs) based upon the 3^{rd} Generation Partnership Project (3GPP) Long term evolution (LTE) Releases 8 and 9 do not adequately respond to the continuously increasing network operator and end-user expectations to adequately handle the increase in voice and data traffic. LTE-advance (LTE-A) Release 10, which was finalized in 2010, extends and enhances LTE RATs, providing the possibility for transmission bandwidth beyond 20 MHz and improving cell deployment with so-called heterogeneous networks (HetNets).

HetNets provide expanded coverage for user equipment (UE) over traditional cellular network topologies to handle increased voice and data traffic in dense urban areas. HetNets consist of a macro cell, which transmits at a high power, with several lower powered nodes (or access points or small calls), such as distributed antennas (remote radio heads (RRHs)), femto base stations, relays and pico base stations. These low powered nodes are deployed to provide enhanced coverage indoors and increase the capacity of the network.

Releases 11/12 (LTE-beyond “LTE-B”), as contemplated by 3GPP, will include further enhancements to local-area (eLA) nodes (or access points or small cells) which would improve traffic capacity and extend achievable data rates of RATs. In particular, LTE-B will achieve improved traffic capacity and extend achievable data rates of RATs by further densification of the network and will create new dual connection scenarios. That is, further eLA deployment will go beyond current HetNets deployment scenarios and will achieve densification of networks by deployment of complementary low-power nodes or small cells operating at higher frequencies, such as 3.5 GHz (possibility as high as 60 GHz) under the coverage of an existing macro node layer operating in lower frequencies such as 2 GHzs. One of the attractive properties of using a 3.5 GHz carrier frequency in an eLA or small cell is that there could be up to a 100 MHz continuous frequency resource available for user equipment. As such, in a dual connection scenarios employing frequency separation a macro eNB will likely be designated to transmit important C-plane signaling, and provide mobility support on one frequency while a local area (LA) cell will be designated to transmit the majority of the traffic in the network on another frequency. In super high traffic areas, eLA could include deployment of hundreds of low powered nodes (or access points (APs)), such as pico and/or femto base stations (as well as relays and RRHs) in multiple sub-cells and sub-sub-cell scenarios.

Despite the above described benefits of improved traffic handling among LA cells in a dual connection scenario, there is still a need for an apparatus, method, and computer program which is capable of allowing a macro cell to coordinate handover in certain situations, as well as provide a redundant link in the event of a link failure in a LA cell.

The following abbreviations that may be found in the specification and/or the drawing figures are defined as follows:
3GPP 3^{rd} Generation Partnership Project
BSR Buffer Status Report
CA Carrier Aggregation
CC Component Carrier
CE Control Element
DL Downlink
D2D Device-to-Device
eNB evolved Node B
eLA evolved Local Area Network
E-UTRAN Evolved Universal Terrestrial Radio Access Network
HetNet Heterogeneous Network
HO Handover
LA Local Area
LAeNB Local Area Evolved Node B
LCG Logical Channel Group
LCID Logical Channel Group Identification
LTE Long Term Evolved
LTE-A Long Term Evolved-Advanced
LTE-B Long Term Evolved-Beyond
MeNB Macro evolved Node B
MAC Media Access Control
MTS Minimum-Time-of-Stay
PCell Primary Serving Cell
QoS Quality of Service
RRH Remote Radio Head
RLF Radio Link Failure
RRC Radio Resource Control
SCell Secondary Serving Cells
TDD Time Division Duplex
TDM Time Division Multiplexing
ToS Time of Stay
UE User Equipment
UL Uplink
UL-SCH Uplink Shared Channel

### SUMMARY

In a first example embodiment, the invention is directed to a method including receiving one or more first buffer status report and one or more second buffer status report by an access point over a link from one or more user equipment in a dual connection deployment scenario in response to a cross link buffer status report trigger.

In a second example embodiment, the invention is directed to an apparatus including at least one processor and at least one memory which stores a computer program. In this embodiment, the at least one memory with the computer program is configured with the at least one processor to cause the apparatus to at least receive one or more first buffer status report and one or more second buffer status report by an access point over a link from one or more user equipment in a dual connection deployment scenario in response to a cross link buffer status report trigger.

In a third example embodiment, the invention is directed to a computer readable memory which stores a computer program, in which the computer program includes instructions for receiving one or more first buffer status report and one or more second buffer status report by an access point over a link from one or more user equipment in a dual connection deployment scenario in response to a cross link buffer status report trigger.

In a fourth example embodiment, the invention is directed to an apparatus including means for receiving one or more first buffer status report and one or more second buffer status report by an access point over a link from one or more user equipment in a dual connection deployment scenario in response to a cross link buffer status report trigger.

In a fifth example embodiment, the invention is directed to a method comprising receiving one or more local area buffer status reports by a macro base station over a macro link or receiving a macro buffer status report by a local area access point over a local area link in a dual connection deployment scenario in response to a cross link buffer status report trigger.

In a sixth example embodiment, the invention is directed to apparatus including at least one processor and at least one memory which stores a computer program. In this embodiment, the at least one memory with the computer program is configured with the at least one processor to cause the apparatus to at least transmitting a local area buffer status report to a macro base station over a macro link or transmitting a macro buffer status report to a local area access point over a local area link in a dual connection deployment scenario in response to a cross link buffer status report trigger.

In a seventh example embodiment, the invention is directed to a computer readable memory which stores a computer program, in which the computer program includes instructions for transmitting a local area buffer status report to a macro base station over a macro link or transmitting a macro buffer status report to a local area access point over a local area link in a dual connection deployment scenario in response to a cross link buffer status report trigger.

In an eight example embodiment, the invention is directed to an apparatus including means for transmitting a local area buffer status report to a macro base station over a macro link or means for transmitting a macro buffer status report to a local area access point over a local area link in a dual connection deployment scenario in response to a cross link buffer status report trigger.

These and other embodiments and aspects are detailed below with particularity.

The foregoing and other aspects of the example embodiments of this invention are further explained in the following Detailed Description, when read in conjunction with the attached Drawing Figures.

### BRIEF DESCRIPTION OF THE DRAWINGS

FIG. 1 illustrates a dual connection scenario in accordance with some example embodiments of the present invention;

FIG. 2 is a simplified block diagram of an example electronic device such as a user equipment suitable for use in practicing some example embodiments of the invention;

FIG. 3 is a simplified block diagram of a first access point or Node, which is an example electronic device suitable for use in practicing some example embodiments of the invention;

FIG. 4 is an illustration of a cross link buffer status report in long form of a media access control control element suitable for use in practicing some example embodiments of the invention;

FIG. 5 is an illustration of a cross link buffer status report in short/truncated form of a media access control control element suitable for use in practicing some example embodiments of the invention;

FIG. 6 is a logical flow diagram which illustrates the operation of a method, and a result of execution of computer program instructions embodied on a non-transitory computer readable memory which provides cross buffer status reporting in view of an evolved node B in dual connection mode and operating in a long term evolution network in accordance with some example embodiments of the present invention; and

FIG. 7 is a logical flow diagram which illustrates the operation of a method, and a result of execution of computer program instructions embodied on a non-transitory computer readable memory, which provides cross buffer status reporting in view of a user equipment in dual connection mode and operating in a long term evolution network in accordance with some example embodiments of the present invention.

These and other embodiments, features, advantages and aspects of the present invention are detailed below with particularity.

### DETAILED DESCRIPTION

Some example embodiments of this invention provide apparatuses, methods, and computer programs that transmit or receive one or more local area buffer status reports by a macro base station over a macro link or transmit or receive a macro buffer status report by a local area access point over a local area link in a dual connection deployment scenario in response to a cross link buffer status report trigger.

In one example embodiment, the cross link buffer status report trigger is one or more measurement events related to a handover (HO) between user equipment and two or more evolved node Bs(eNBs) in a local area. In another example embodiment, the cross link buffer status report trigger is a radio link failure (RLF) of the serving link. In another example embodiment, an eNB, such as a macro eNB or local area LA eNB, sends a buffer condition request to each user equipment (UE) camped on either NB. The buffer condition request instructs the UE to transmit the capacity of its uplink buffers to either the macro eNB, or to the local area LA eNB, or both, and over the macro link, the local area link, or both. Yet another example embodiment provides that a serving eNB can enable or disable the cross link buffer status report trigger. Other example embodiments provide various non-limiting formatting techniques for reporting macro local area BSRs in short, truncated and long media access control (MAC) control elements.

As used throughout this disclosure, a buffer status report (BSR) refers to a report generated by user equipment (UE) detailing the capacity of the UE's uplink (UL) data buffers. Also, “cross link buffer status reporting,” as used throughout this disclosure, refers to reporting BSRs with respect to a macro evolved Node B over local area link to a local area evolved Node B or reporting BSRs with respect to a local area evolved Node B over macro link to a macro evolved Node B. Prior to describing more fully some example embodiments of the present invention, a description of relevant functions and features of BSR in long term evolution and LTE-A is provided below followed, by a description of some of the benefits of the present invention.

In universal terrestrial radio access networks (UTRANs) and evolved universal terrestrial radio access networks (eUTRANs), each eNB contains a MAC scheduler adapted to distribute the available radio resources in one cell among the user equipment camped on a eNB (e.g., the UE's serving eNB) and among the radio bearers of each UE. The MAC scheduler allocates downlink (DL) or uplink (UL) radio resources to each UE after considering the capacity of the DL data buffered in the eNB, and after considering buffer status reports (BSRs) received from the UE. The BSRs relate to the amount of data to be transmitted over an uplink shared channel (UL-SCH). In such an allocation process, the MAC scheduler also considers the quality of service (QoS) requirements of each configured radio bearer and selects the size of a MAC packet data unit (PDU) which will contain a BSR.

The Third Generation Partnership Project (3GPP) has standardized BSR procedures for reporting the amount of data available for transmission in the UL buffers of a UE to its serving eNB. See Subsection 5.4.5 (“Buffer Status Reporting”) 3GPP TS 36.321. According to that standard, the UE must consider all radio bearers which are not suspended, and may consider radio bearers which are suspended. There are two types of BSRs defined by the standard: (1) long BSRs and (2) short BSRs. A long BSR reports the amount of data for four logical channel groups, whereas the short BSR reports the amount of data for only one logical channel group. Whether a long or short BSR is transmitted depends on: (i) the amount of available UL transmission resources for sending the BSR; (ii) how many groups of logical channels have non-empty buffers, and (iii) whether a specific event is triggered at the UE.

According to the standard, there are several triggering events which will cause a UE to issue a BSR. For example, a so-called “regular BSR” is triggered if data arrives for a logical channel which has a higher priority than the logical channels whose buffers previously contained data, or if data becomes available for any logical channel not previously having data available for transmission. Another BSR triggering event occurs if a retxBSR-Timer expirers while there is data available for transmission. The retxBSR-Timer provides a mechanism to recover from situations where a BSR is transmitted but not received. Yet another triggering event occurs whenever a periodic BSR-Timer expires, which is called a periodic BSR. The retxBSR-Timer and periodic BSR-Timer are transmitted to the UE from the serving eNB by way of radio resource control (RRC) signaling. A BSR is also triggered if it is determined that there is available space in a MAC PDU which can accommodate a BSR. This situation is called “padding BSR.” Each MAC subheader consists of a logical channel ID (LCID) and a length (L) field. The LCID indicates whether the corresponding part of the MAC payload is a MAC control element and, if not, to which logical channel the related MAC SDU belongs. The L field indicates the size of the related MAC SDU or MAC control element. As such, MAC control elements are used for MAC-level peer-to-peer signaling.

For dual connection systems, such as those described in the background of invention section of this disclosure, the local area evolved Node B (LAeNB) and Macro evolved Node B (MeNB) each have their own independent MAC scheduler. As such, each UE must independently report two sets of BSRs; a macro BSR to the MeNB over a macro link, and a local area (LA) BSR to the LA eNB over a LA link. In other words, the event triggering rules mentioned above in the 3GPP standard are not sufficient for a dual connectivity scenario.

Some example embodiments of the present invention introduce cross link buffer status reporting in a dual connection scenario. That is, as explained in more detail below, some example embodiments of the present invention provide that in certain situations a macro BSR is transmitted over a LA link to a LA eNB, or a LA BSR is transmitted over a macro link to a macro eNB. Such cross links provide the benefit of allowing a MeNB to assist or control the mobility of one or more UEs. In such a situation, the MeNB can take the UE's BSR on LA link into account for its mobility decision making. For example, in the event that signal strength of a LA link deteriorates, or is congested with network traffic, a MeNB can move some urgent data resource blocks (DRB) to macro links if the service is time sensitive and BSR is still high. On the other hand, if the LA BSR shows the traffic is delay sensitive and the buffer capacity is low, the MeNB may keep the radio bearer running on LA cell. Also, in the event of a dual connection failure, a timely report of leftover buffer of LA link also can assist MeNB's better mobility handling.

In addition, some example embodiments of the present invention also provide other benefits in the form of enhanced mobility management in a dual connection scenario. That is, the above mentioned BSR triggers described in the 3GPP specification were amended to strike out BSR reporting in the event of a serving cell change due to the fact that this information was already available by way of RRC signaling. However, for a dual connection case, such a BSR trigger with respect to a serving cell change, can assist the MeNB in its decision making with respect to mobility in dual connection scenarios. Some example embodiments of the present invention provide various handover measurements as additional BSR triggers as described in more detail below.

Another benefit of the present invention is that some example embodiments of the present invention support time division duplex (TDD) transmission of two ULs in a dual connection scenario. That is, as explained in more detail below, some example embodiments of the present invention reduce intermodulation interference among the two ULs (LA and MeNB) and enable low cost UE radio frequency (RF) reuse by restricting the time in which each UL can be transmitted. For example, in the case of two BSRs triggered in two links, cross link reporting can avoid the possible dropping loss due to time division multiplexing (TDM) UL. Moreover, if two BSRs are available, they can be utilized to co-ordinate the UL transmission pattern among two links.

Yet another benefit of the present invention is an improved power efficiency of the UEs and eNBs in the dual connection network. That is, in a dual connection scenario involving frequency separation, a MeNB uplink requires a higher transmission power than the LAeNB uplink. As such an example embodiment of the present invention provides another benefit. That is, some UL reports which are direct to MeNB can be transmitted to the LAeNB instead. As such, some example embodiments of the present invention can provide a dual connection deployment scenario where two DLs are enabled but only one LA UL is used for dual connection deployment to save power. In one non-limiting example, cross link BSR can involve reporting of MeNB to LAeNB, and LAeNB forwarding of such info to MeNB through a backhaul (e.g., over fiber connections as opposed to over the air). Also, once dual connection is established, transmission of the BSR, or other reports on LA link could also avoid requesting UL grant from the macro link.

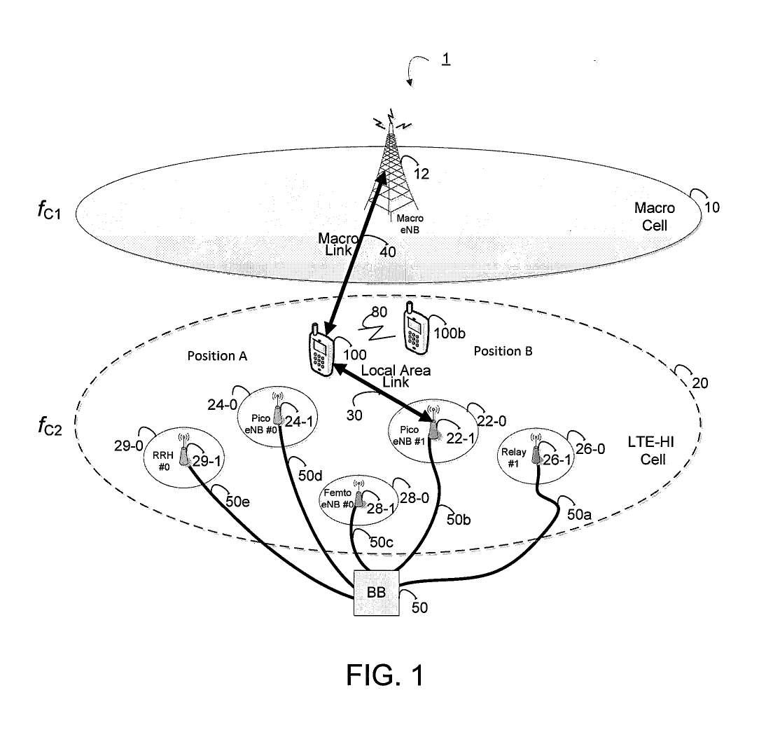

Referring now to FIG. 1, a wireless communications system 1 is disclosed as one possible non-limiting example of a dual connection scenario in accordance with some example embodiments of the present invention. As shown in FIG. 1, a macro cell 10 includes a connection node (or access point), such as a macro evolved Node B (MeNB) 12. Also shown in FIG. 1 is a long term evolution hotspot and indoor (LTE-HI) cell 20 which underlays the macro cell 10. LTE-HI 20 can be referred to as an enhanced local area (eLA) cell or booster cell while macro cell 10 can be referred to as an anchor cell. In this non-limiting example, the macro cell 10 is transmitting and receiving at a first carrier frequency f_{c1} while LTE-HI is transmitting and receiving at a second carrier frequency f_{c2}. In one example embodiment f_{c1 is} 2 Ghz is utilized. However, in alternatives embodiments, macro cell 10 can be configured by a network operator to transmit and receive at other frequencies greater than or less than 2 GHz. LTE-HI cell 20 operates at a higher frequency, such as f_{c2} adapted to 3.5 GHz. In an alternative example embodiment, LTE-HI cell 20 can transmit and receive at higher frequencies, such as one as high as 60 GHz, or lower frequencies below 2 GHz. Also, LTE-HI cell 20 can operate at lower or higher power levels than a macro cell 10.

A cluster of local areas (LA) cells (i.e., LA cell 22-0, LA cell 24-0, LA cell 26-0, LA cell 28-0, and LA cell 29-0) are shown dispersed throughout LTE-HI 20, along with two dead spots (Position A and Position B). Each LA cell in LTE-HI cell 20 operates at f_{c2}. Within each LA cell is a connection node (or access point) such as an eNB, a picoeNB, a femtoeNB, a relay or a remote radio head (RRHs). For example, LA cell 22-0 contains a Pico eNB #1 (22-1), LA cell 24-0 contains a Pico eNB #0 (24-1), LA cell 26-0 contains a relay #1 (26-1), LA cell 28-0 contains a Femto eNB #0 (28-1) and LA cell 29-0 contains a remote radio head #0 (29-1). Each connection node (or access point) can be configured by a network operator to transmit and receive at the 3.5 GHz frequency assigned to the LTE-HI 20, or at higher frequencies such as 60 GHz, or lower frequencies below 2 GHz. Also, each individual LA cell can operate at a lower or higher power level than the macro cell 10. Each connection node (or access point) is equipped with an optical backhaul link coupled to an optical fiber (OF) link, such as OF 50(a), OF 50(b), OF 50(c), OF 50(d) and OF 50(e) and coupled to a broad band (BB) connection 50. MeNB 12 is also is equipped with an optical backhaul link coupled to an optical fiber (OF) link (not shown) and coupled directly or indirectly to a broad band (BB) connection 50. In some embodiments of the present invention, a hub or switch (not shown) can be installed to couple the nodes to BB 50 to reduce the need for fiber optical cabling. In an alternative example embodiment, the Femto eNBs and pico eNBs can be coupled by way of WiFi or other LAN access technologies as known in the art.

The number of LA cells, dead spots and types of connection nodes, or their positioning within LTE-HI 20, is merely presented for illustrating some example embodiments of the present invention and are not intended to limit the some example embodiments of the present invention to the specific deployment scenario shown in FIG. 1. In fact, each LA cell can be deployed anywhere within a LTE-HI 20 (or more or fewer LA cells can be added/subtracted), and LTE-HI 20 can either contain tightly packed or loosely packed groupings of LA cells depending upon whether the deployment scenario requires providing booster signal coverage and/or corner signal coverage in a specific area of a macro cell deployment (ultimately depending upon the network operator and depending upon the specific deployment scenario). For example, one sector of a macro cell might be located near a transit hub which is proximately located close to a downtown shopping area, as well as proximally located near a business district. Such an area would be tightly packed with LA cells. While another sector of the LTE-HI cell might be loosely packed with LA cells due to lower demand for voice and data traffic (e.g., Position A and Position B). In other words, the distribution of LA cells is not necessarily uniform in some example embodiments of the present invention. However, alternative embodiments of the present invention can include a uniform distribution of LA cells in a LTE-HI cell deployment. Also shown in FIG. 1 is user equipment 100b which is proximately located to user equipment 100. Both user equipment are adapted to support device-to-device (D2D) communication 80 and support transmitting and receiving cross link buffer status reporting in accordance with some example embodiments of the present invention. In other words, some example embodiments of the present invention provide that the user equipment adapted for D2D dual connection mode functions similar to the local area access points (e.g., eNBs, pico eNBs, Femto eNB, RRH or relay)) in handling cross link BSR triggers as described in more detail below.

FIG. 1 also discloses user equipment (UE) 100 adapted for transmitting and receiving on f_{c1} and f_{c1} and suitable for carrying out some example embodiments of the present invention. As such, UE 100 is adapted to transmit and receive over two links: a macro link 40 between UE 100 and macro eNB 12 and (simultaneously) a local area link 30 between UE 100 and pico eNB 22-1. The connection nodes, such as macro eNB 12, pico eNB #1 22-1, pico eNB #0 24-1, femto eNB #0 28-1, relay #1 26-1 and RRH 29-1 as well as UE 100, are adapted for communicating on various and multiple radio access networks (RANs). Some non-limiting examples of RANs are Global System for Mobile Communications radio access networks, enhanced data rates for GSM evolution (EDGE) radio access network, universal terrestrial radio access network (UTRAN), evolved universal terrestrial radio access network (EUTRAN) as described in long term evolution/long term evolution advanced/long term evolved-advanced (LTE/LTE-A), as well as first responder network or other similar radio access networks or cellular networks employing Wideband Code Division Multiple Access or High Speed Packet Access.

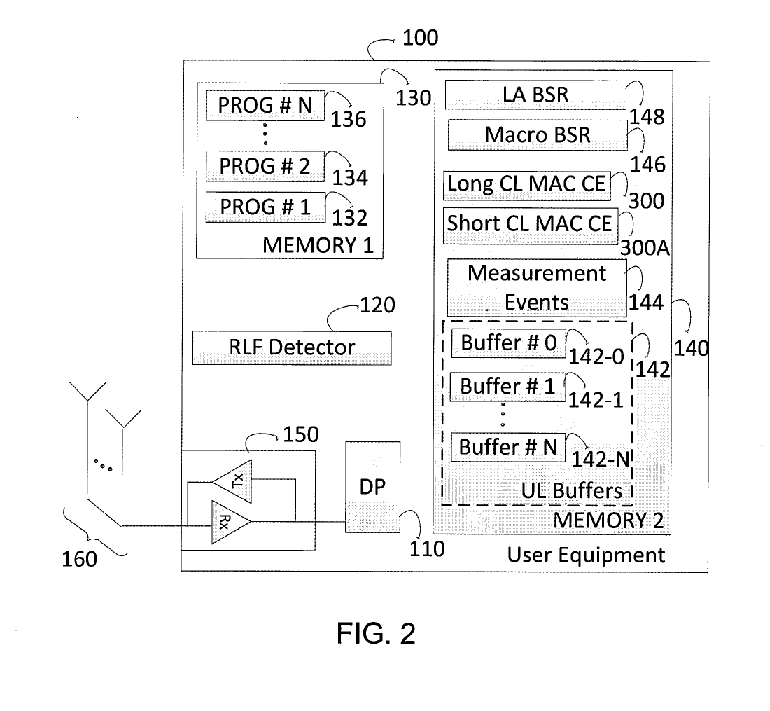

Referring now to FIG. 2, a simplified block diagram of a UE 100 is shown as an example electronic device suitable for use in practicing some example embodiments of the invention. UE 100 includes one or more processors, such as at least one data processor (DP) 110, a first computer-readable memory 130, which stores a plurality of computer programs, such as PROG #1 (132), PROG #2 (134) and PROG #N (136), suitable for carrying out the various example embodiments of the present invention. A second computer-readable memory 140 stores one or more local area buffer status reports (LA BSR) 148 and one or more Macro buffer status reports (Macro BSR) 146. Also shown in second memory 140 are various measurement events 144 recorded by UE 100 and reported to an eNB. In one example embodiment, a cross link BSR is triggered in response or incidental to the measurement events 144. The measurement events are defined in 3GPP TS TS 36.331 (e.g., 5.5.4 et seq.). According to that specification eight events trigger the UE to send a report to an eNB. Those measurement events include the following handover related events:

(i) an event A1 indicating that a serving cell becomes better than absolute threshold;
(ii) an event A2 indicating that a serving cell becomes worse than absolute threshold;
(iii) an event A3 indicating that a neighbor cell becomes an amount of offset better than a primary cell;
(iv) an event A4 indicating that neighbor cell becomes better than absolute threshold;
(v) an event A5 indicating that the primary cell becomes worse than absolute threshold one and the neighbor cell becomes better than another absolute threshold two;
(vi) an event A5 indicating that the neighbor cell becomes amount of offset better than the serving cell;
(vii) an event B1 indicating that the neighbor cell becomes better than absolute threshold; and
(viii) an event B2 indicating that the primary cell becomes worse than absolute threshold one and the neighbor cell becomes better than another absolute threshold two.

Also shown in second memory 140 are the uplink buffers 142 which are adapted for allowing UE 100 to transmit on an UL shared channel (UL-SCH). In this non-limiting example embodiment, buffer #0 (142-0), buffer #1 (142-1), and buffer #N (142-N) are shown for illustration purposes. UE 100 can contain multiple UL buffers beyond the numbers shown in FIG. 2.

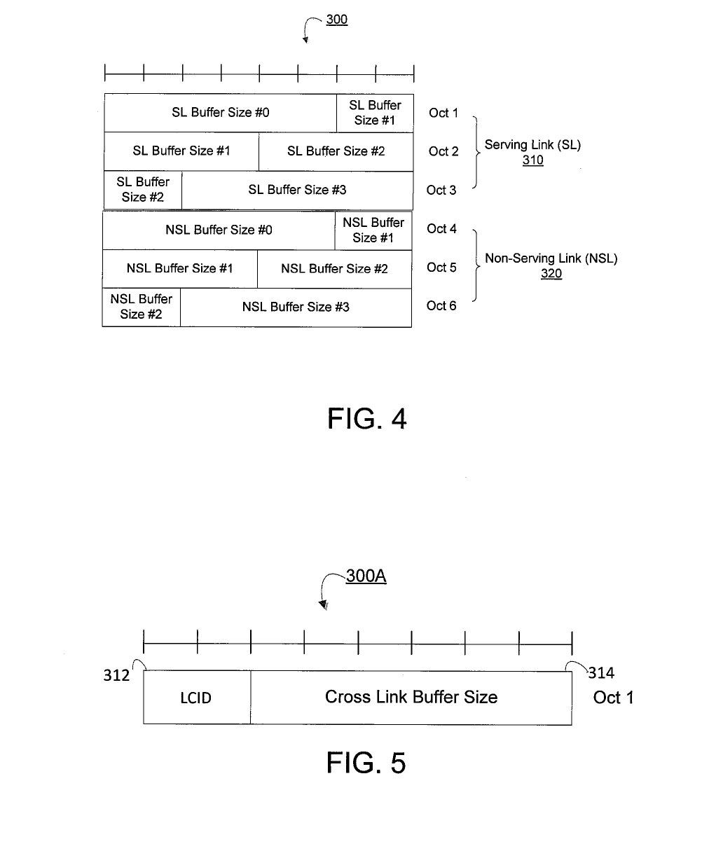

The DP 110 and PROG #1 (132) can trigger a cross link BSR operation in accordance with some example embodiments of the present invention. For example, PROG #1 (132) can selectively transmit a local area buffer status report 148 to a macro base station over a macro link or transmit a macro buffer status report 146 to a local area access point over a local area link in a dual connection deployment scenario in response to a cross link buffer status report trigger. The cross link buffer status report trigger can in one example embodiment be a specific measurement event 144 (e.g., A1-A6 or B1-B2). Yet another cross link buffer status report trigger can be a radio link failure as detected by RLF detector 120. In other words, if RLF detector 120 detects a loss of a radio link, then the present invention provides a redundant link so as to avoid an instance of loss of transmission. The Macro BSR 146 and/or LA BSR 148 are formatted into a long cross link MAC CE 300 or short cross link MAC CE 300A as described below in reference to FIGS. 4 and 5 and transmitted to either MeNB or LAeNB. Accordingly, UE 100 receives a message from MeNB or LAeNB in response to the transmitted LA BSR 148 or transmitted macro buffer status report, said message adapted for directing an allocation of a plurality of logical channels or one or more logical channel groups over the local area link or over the macro link. For example, as shown in FIG. 1, should UE 100 move toward dead spots, such as Position A or Position B, coverage will be maintained by way of MeNB 12.

UE 100 also includes a plurality of transceivers 150 and a plurality of radio access technology antennas 160. The plurality of transceivers 150 can be a Long term evolution/long term evolution advanced/long term evolved beyond (LTE/LTE-A/LTE-B) transceiver, or any similar transceiver. Such non-limiting examples include any other transceiver capable of communicating with a universal mobile telecommunications system, an evolved universal mobile telecommunications Terrestrial Radio Access Network, Global System for Mobile Communications radio access networks, enhanced data rates for GSM evolution (EDGE) radio access network, universal terrestrial radio access network (UTRAN), evolved universal terrestrial radio access network (EUTRAN) as described in long term evolution/long term evolution advanced/long term evolved-advanced (LTE/LTE-A) as well as first responder network or other similar radio access networks or cellular networks employing Wideband Code Division Multiple Access or High Speed Packet Access.

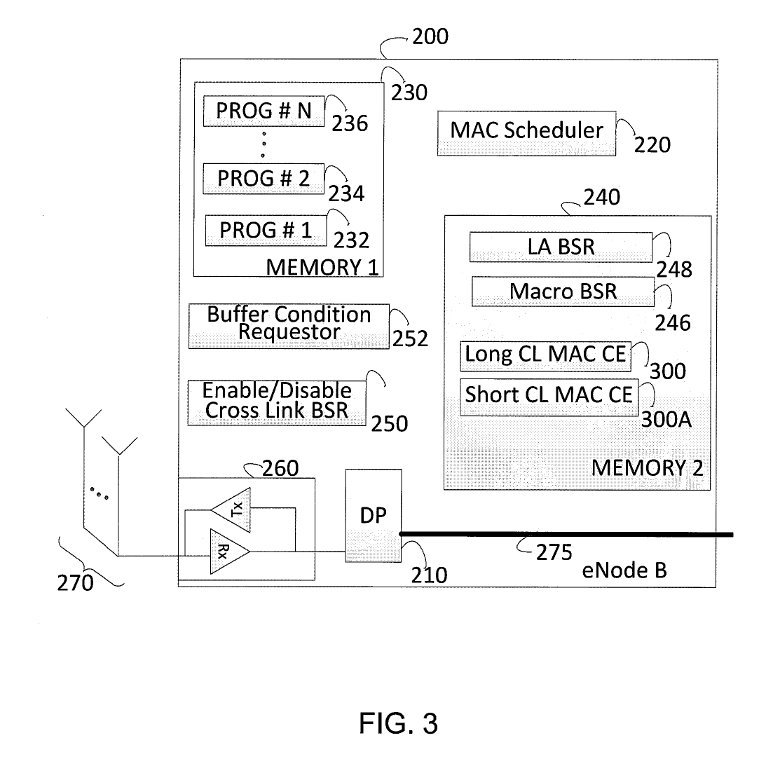

Referring now to FIG. 3, a simplified block diagram of a first access point or Node, which can be an evolved Node B (eNB) 200, is shown as an example electronic device suitable for use in practicing some example embodiments of the invention. Referring back to FIG. 1, eNB 200 can be for example MeNB 12, Pico eNB #0 (24-1), Pico eNB #1 (22-1) FemtoeNB #0 (28-1) As shown in FIG. 3 eNB 200 includes one or more processors, such as at least one data processor (DP) 210, a first computer-readable memory 230 which stores a plurality of computer programs such as PROG #1 (232), PROG #2 (234) and PROG #N (236), suitable for carrying out the various example embodiments of the present invention. For example, PROG #1 (232) together with DP 210 control the operation of the MAC scheduler 220. MAC scheduler 220 which is adapted to distribute the available radio resources in a cell (e.g. Macro and LA cells) among the user equipment camped on a LA cell such as pico or Femto eNBs (e.g., the UE's serving pico or Femto eNB) and among the radio bears of each UE. PROG #2 (234) together with DP 210 send a buffer condition request to each UE and receiver LA BSR 248 and macro BSR 246. In one example embodiment, the buffer condition request can be issued to both the serving link and non-serving link or only one link. The serving link can be either the LA link or macro Link and similarly the non-serving link can be LA link or Macro Link. In another example embodiment, a UE will trigger a regular BSR for “certain” link(s) once received such an order. PROG #1 (232) together with DP 210 is adapted to send a signal to one or more UEs to enable or disable the cross link BSR trigger in accordance with some example embodiments of the present invention. In one example embodiment, higher layer signaling such as radio resource control (RRC) signaling or determined according to UL TDM pattern signal to transmit the enable/disable instruction to the UEs.

A second computer-readable memory 240, stores LA BSR 248 and macro BSR 246. Also second computer-readable memory 240 stores either a long cross link MAC CE 300 or short cross link MAC CE 300A as described in more detail below in reference to FIGS. 4 and 5 as well as the description of the method and operation of a computer program capable of carrying out some example embodiments of the present invention.

Although FIG. 3 depicts a first computer-readable memory 230 and a second computer-readable memory 240, eNB 200 may include one or more additional memories or fewer memory units for carrying out the example embodiments of the present invention. Moreover, the programs described above (e.g., PROG #1 (232), PROG #2 (234), and PROG #N (236)) are not limited to a specific memory location (e.g., first computer-readable memory 230 and second computer-readable memory 240). FIG. 3 is merely one possible non-limiting example embodiment of the present invention.

Also as shown in FIG. 3, eNB 200 includes a plurality of transceivers 260 and a plurality of radio access technology antennas 270. The plurality of transceivers 260 can be a Long term evolution/long term evolution advanced/long term evolved beyond (LTE/LTE-A/LTE-B) transceiver, or any similar transceiver. Such non-limiting examples include any other transceiver capable of communicating with a universal mobile telecommunications system, an evolved universal mobile telecommunications Terrestrial Radio Access Network, Global System for Mobile Communications radio access networks, enhanced data rates for GSM evolution (EDGE) radio access network, universal terrestrial radio access network (UTRAN), evolved universal terrestrial radio access network (EUTRAN), as described in long term evolution/long term evolution advanced/long term evolved-advanced (LTE/LTE-A), as well as a first responder network or other similar radio access networks or cellular networks employing Wideband Code Division Multiple Access or High Speed Packet Access. Also shown in FIG. 3 is an X2 interface adapted to provide support for backhaul operations among one or more cooperative eNBs, Buffer Condition Requestor 252 and Enable/Disable Cross Link BSR 250 which will be explained in detail below.

Referring now to FIG. 4, a cross link BSR MAC CE 300 in long format is shown in accordance with some example embodiments of the present invention. As shown in FIG. 4, cross link BSR MAC CE 300 includes six octals of data, each capable of containing information with respect to 8 LCIDS. Octals 1 through 3 contain four LCIDS with respect to a serving link (SL) 310, which can be a macro link or LA link. Each octal is separated and contains data in an arbitrary manner. That is, the SL buffers #0-#3 in FIG. 4 are merely provided for illustration purposes and are not meant to limit the example embodiments of the present invention to one specific allocation of buffer sizes to each octal. Similarly, Octals 4 through 6 contain four LCIDS with respect to a non-serving link (NSL) 320, which can be a macro link or LA link. Each octal is separated and contains data in an arbitrary manner. That is, the NSL buffer #0-#3 in FIG. 4 are merely provided for illustration purposes and are not meant to limit the example embodiments of the present invention to one specific allocation of buffer sizes to each octal.

In one example embodiment, the buffer status report for a non-serving link (e.g., LA link or macro Link) may be triggered when there is still padding bits available after padding the BSR for the serving link (e.g., LA link or Macro Link). In another example embodiment, a long BSR with two links may put its own link BSRs in the first three bytes and put the other link BSRs in the next three bytes or in opposite order.

Referring now to FIG. 5, a cross link BSR MAC CE 300A in short or truncated format is shown in accordance with some example embodiments of the present invention. As shown in FIG. 5, a single LCID 312 is provided together with a cross link buffer size 314 corresponding to the non-serving link as described in more detail below in accordance with some example embodiments of the present invention.

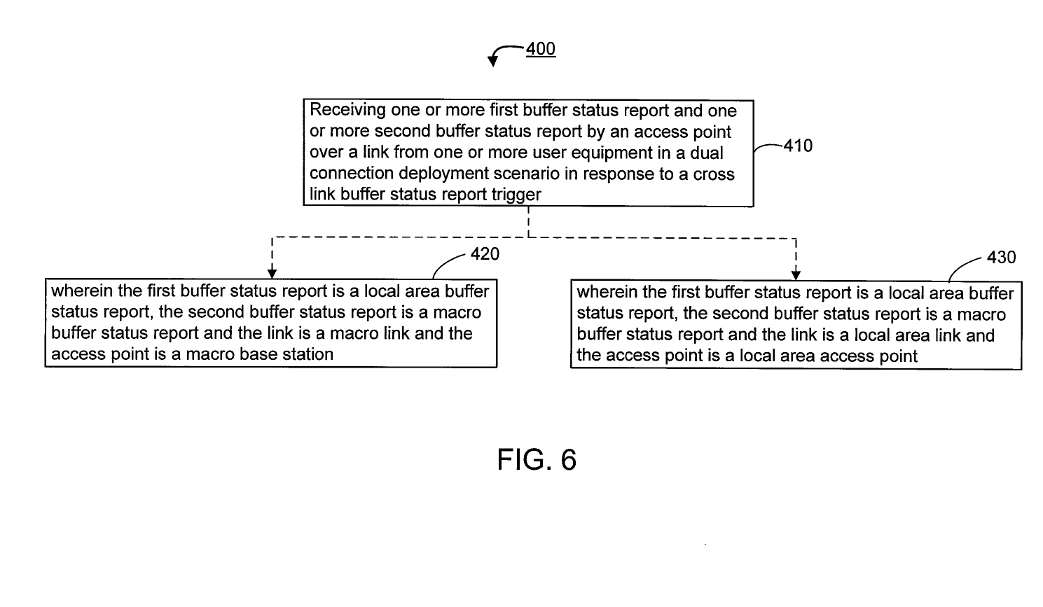

FIG. 6 is a logical flow diagram which illustrates the operation of a method, and a result of execution of computer program instructions embodied on a non-transitory computer readable memory, which provides cross buffer status reporting in view of an evolved node B in dual connection mode and operating in a long term evolution network 400 in accordance with some example embodiments of the present invention. As shown in FIG. 6, the method or execution of computer operations includes receiving one or more first buffer status report and one or more second buffer status report by an access point over a link from one or more user equipment in a dual connection deployment scenario in response to a cross link buffer status report trigger (410).

In one example embodiment the first buffer status report is a local area buffer status report, the second buffer status report is a macro buffer status report and the link is a macro link and the access point is a macro base station (420). As described in more detail below, this embodiment allows buffer status reporting to be handled by the macro base station in a scenario based upon the priority of the data, traffic or unavailability of one or more local area access points.

In another example embodiment, the first buffer status report is a local area buffer status report, the second buffer status report is a macro buffer status report and the link is a local area link and the access point is a local area access point (430). In this particular embodiment the macro base station may be unavailable and the buffer status report is send to one or more local area access points.

In one example embodiment, a cross link buffer status report trigger includes a handover measurement report trigger adapted to instruct a user equipment to handover to a target base station, delay a handover to the target base station or find another target base station based upon one or more measurement events. The one or more measurement events, include a trigger in response to one or more measurement events, wherein the measurement events are selected from a group consisting of an event A1 indicating that a serving cell becomes better than absolute threshold, an event A2 indicating that a serving cell becomes worse than absolute threshold, an event A3 indicating that a neighbor cell becomes an amount of offset better than a primary cell, an event A4 indicating that neighbor cell becomes better than absolute threshold, an event A5 indicating that the primary cell becomes worse than absolute threshold one and the neighbor cell becomes better than another absolute threshold two, an event A5 indicating that the neighbor cell becomes amount of offset better than the serving cell, an event B1 indicating that the neighbor cell becomes better than absolute threshold, and an event B2 indicating that the primary cell becomes worse than absolute threshold one and the neighbor cell becomes better than another absolute threshold two, wherein the cross link buffer status reporting trigger results in an evolved Node B directing a handover from the primary cell to one or more secondary cells.

In another example embodiment, a cross link buffer status report trigger includes a radio link failure trigger adapted to indicate a radio link failure of the macro link or the local area link, wherein, in response to an indication of a local area link failure transmitting the local area buffer status report link buffer status report to the macro base station over the macro link or in response to an indication of a macro link failure transmitting a macro buffer status report to a local area access point over the local area link, wherein either the macro base station or local area access point selectively direct a user equipment to perform a radio resource control establishment procedure over an operation radio link.

In another example embodiment, if the local area buffer status report indicates one or more of the plurality of logical channels or one or more logical channel groups is a high priority logic channel and the macro link has a low traffic load then the one or more high priority logical channels or one or more high priority logical channel groups are directed to the macro link.

In another example embodiment, if the local area buffer status report indicates that the local area link has a low traffic load then the one or more high priority logical channels or one or more high priority logical channel groups are directed to stay on the local area link.

In another example embodiment, if the local area buffer report indicates that data storage capacity corresponding to the plurality of high priority logical control channels or one or more high priority logical channel groups does not exceeds a predetermined data storage threshold then the one or more high priority logical channels or one or more high priority logical channel groups are directed to the macro link.

In another example embodiment, the predetermined data storage threshold is less than 25% capacity of an available local buffer memory, less than 50% capacity of the available local buffer memory or less than 75% of the available buffer local buffer memory.

In another example embodiment, the method or execution of computer code includes receiving a buffer condition request from either the macro base station or the local area access point. The buffer condition request is adapted to direct the user equipment to report back the local area buffer status report and/or the macro buffer status report and transmit the local area buffer status report and/or the macro buffer status report to either the macro base station or the local area access point.

In another example embodiment, the method or execution of computer code comprising receiving an enable/disable cross link buffer status report trigger adapted to enable or disable the cross link buffer status trigger.

In another example embodiment, the enable/disable cross link buffer status report is a radio resource control message or an uplink time division multiplexing pattern.

In another example embodiment, the cross link buffer status report trigger comprises a macro link short buffer status report logical channel identity, a local area link short buffer status report logical channel identity, a macro and local area link short buffer status report logical channel identity, a macro link truncated buffer status report logical channel identity, a local area link truncated buffer status report logical channel identity, a macro and local area link truncated buffer status report logical channel identity, a macro link long buffer status report logical channel identity, a local area long buffer status report logical channel identity and a macro and local area link long buffer status report logical channel identity, wherein the macro and local area link long buffer status report logical channel identity is adapted such that either the macro or local area link buffer status report is disposed in the first three bytes or the next three bytes.

In another example embodiment, wherein the macro link buffer status report and local area buffer status report are further padded by way of cross link padding the non-serving link when there is available padding bits available after padding the serving link. The cross link padding comprises padding long buffer status report for the serving link only, padding long buffer status report for non-serving link only, padding long buffer status report for the serving and non-serving links, padding short/truncated buffer status report for the serving link then padding short/truncated buffer status report for the other link, wherein the serving link or non-serving link are either the macro link or the local area links.

In another example embodiment, the long buffer status report is implemented in a media access control control element containing information pertaining to the serving and non-serving links and allocate a plurality of buffer sizes for each buffer status report disposed in at least one or more octals.

In another example embodiment, the local area buffer status report is received and transmitted on a first carrier frequency and macro buffer status report is received and transmitted on a second carrier frequency over an evolved universal terrestrial radio access network, universal terrestrial radio access network, global system for mobile communication network, enhanced data rates for global system for mobile communication evolution network, a public safety network or a first responder network.

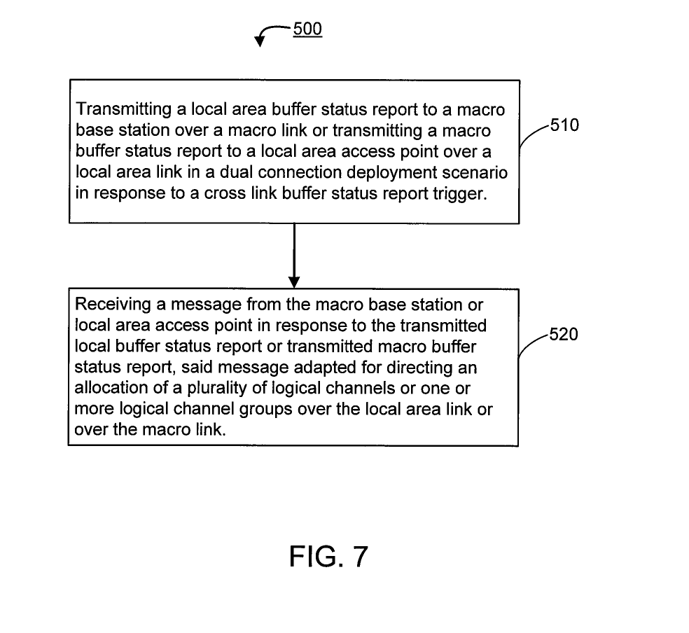

FIG. 7 is a logical flow diagram which illustrates the operation of a method, and a result of execution of computer program instructions embodied on a non-transitory computer readable memory, which provides cross buffer status reporting in view of an User equipment in dual connection mode and operating in a long term evolution network 500 in accordance with some example embodiments of the present invention. As shown in FIG. 7, the method or execution of computer operations includes transmitting a local area buffer status report to a macro base station over a macro link or transmitting a macro buffer status report to a local area access point over a local area link in a dual connection deployment scenario in response to a cross link buffer status report trigger (510) and receiving a message from the macro base station or local area access point in response to the transmitted local buffer status report or transmitted macro buffer status report, said message adapted for directing an allocation of a plurality of logical channels or one or more logical channel groups over the local area link or over the macro link (520).

In one example embodiment, the cross link buffer status report trigger includes a trigger in response to one or more measurement events, wherein the measurement events are selected from a group consisting of an event A1 indicating that a serving cell becomes better than absolute threshold, an event A2 indicating that a serving cell becomes worse than absolute threshold, an event A3 indicating that a neighbor cell becomes an amount of offset better than a primary cell, an event A4 indicating that neighbor cell becomes better than absolute threshold, an event A5 indicating that the primary cell becomes worse than absolute threshold one and the neighbor cell becomes better than another absolute threshold two, an event A5 indicating that the neighbor cell becomes amount of offset better than the serving cell, an event B1 indicating that the neighbor cell becomes better than absolute threshold, and an event B2 indicating that the primary cell becomes worse than absolute threshold one and the neighbor cell becomes better than another absolute threshold two, wherein the cross link buffer status reporting trigger results in an evolved Node B directing a handover from the primary cell to one or more secondary cells.

In another example embodiment, the cross link buffer status report trigger comprises a radio link failure trigger adapted to indicate a radio link failure of the macro link or the local area link, wherein, in response to an indication of a local area link failure receiving the local area buffer status report link buffer status report by the macro base station over the macro link or in response to an indication of a macro link failure receiving a macro buffer status report by a local area access point over the local area link, wherein either the macro base station or local area access point selectively direct a user equipment to perform a radio resource control establishment procedure over an operation radio link.

In another example embodiment, if the local area buffer status report indicates one or more of the plurality of logical channels or one or more logical channel groups is a high priority logic channel and the macro link has a low traffic load then the one or more high priority logical channels or one or more high priority logical channel groups are directed to the macro link.

In another example embodiment, if the local area buffer status report indicates that the local area link has a low traffic load then the one or more high priority logical channels or one or more high priority logical channel groups are directed to stay on the local area link.

In another example embodiment, if the local area buffer report indicates that data storage capacity corresponding to the plurality of high priority logical control channels or one or more high priority logical channel groups does not exceeds a predetermined data storage threshold then the one or more high priority logical channels or one or more high priority logical channel groups are directed to the macro link.

In another example embodiment, the predetermined data storage threshold is less than 25% capacity of an available local buffer memory, less than 50% capacity of the available local buffer memory or less than 75% of the available buffer local buffer memory.

In another example embodiment, the method or execution of computer code includes transmitting a buffer condition request from either the macro base station or the local area access point. The buffer condition request is adapted to direct the user equipment to report back the local area buffer status report and/or the macro buffer status report and receive the local area buffer status report and/or the macro buffer status report by either the macro base station or the local area access point.

In another example embodiment, the method or execution of computer code includes transmitting an enable/disable cross link buffer status report trigger adapted to enable or disable the cross link buffer status trigger.

In another example embodiment, the enable/disable cross link buffer status report is a radio resource control message or an uplink time division multiplexing pattern.

In another example embodiment, the cross link buffer status report trigger comprises a macro link short buffer status report logical channel identity, a local area link short buffer status report logical channel identity, a macro and local area link short buffer status report logical channel identity, a macro link truncated buffer status report logical channel identity, a local area link truncated buffer status report logical channel identity, a macro and local area link truncated buffer status report logical channel identity, a macro link long buffer status report logical channel identity, a local area long buffer status report logical channel identity and a macro and local area link long buffer status report logical channel identity, wherein the macro and local area link long buffer status report logical channel identity is adapted such that either the macro or local area link buffer status report is disposed in the first three bytes or the next three bytes.

In another example embodiment, the macro link buffer status report and local area buffer status report are further padded by way of cross link padding the non-serving link when there is available padding bits available after padding the serving link, said cross link padding comprising padding long buffer status report for the serving link only, padding long buffer status report for non-serving link only, padding long buffer status report for the serving and non-serving links, padding short/truncated buffer status report for the serving link then padding short/truncated buffer status report for the other link, wherein the serving link or non-serving link are either the macro link or the local area links.

In another example embodiment, the long buffer status report is implemented in a media access control control element containing information pertaining to the serving and non-serving links and allocate a plurality of buffer sizes for each buffer status report disposed in at least one or more octals.

In another example embodiment, the local area buffer status report is received and transmitted on a first carrier frequency and macro buffer status report is received and transmitted on a second carrier frequency over an evolved universal terrestrial radio access network, universal terrestrial radio access network, global system for mobile communication network, enhanced data rates for global system for mobile communication evolution network, a public safety network or a first responder network.

Some non-limiting example embodiments of this invention may be implemented at least in part by computer software stored on the non-transitory memory which is executable by a processor, or by hardware, or by a combination of tangibly stored software and hardware (and tangibly stored firmware). Electronic devices implementing these aspects of the invention need not be the entire devices as depicted at FIGS. 2 (e.g., user equipment) and 3 (e.g., eNode B), but some example embodiments may be implemented by one or more components of same, such as the above-described tangibly stored software, hardware, firmware and processor or micro-controllers, or a system on a chip (SOC), or an application specific integrated circuit (ASIC).

Various embodiments of the computer readable memory such as those disclosed in FIG. 2 include any data storage technology type which is suitable to the local technical environment, including, but not limited to, semiconductor based memory devices, magnetic memory devices and systems, optical memory devices and systems, fixed memory, removable memory, disc memory, flash memory, DRAM, SRAM, EEPROM and the like. Various embodiments of the data processors include, but are not limited to, general purpose computers, special purpose computers, microprocessors, digital signal processors (DSPs) and multi-core processors.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.” The reference throughout this disclosure to a UE as shown in FIGS. 1 and 2 may be embodied on a cellular phone, a personal digital assistant (PDA), a wireless modem, a wireless communication device, a laptop, a netbook, a tablet or any other device cable of communicating with a E-UTRAN, UTRAN or GERAN enabled device.

Further, some of the various features of the above non-limiting example embodiments may be used to advantage without the corresponding use of other described features. The foregoing description should therefore be considered as merely illustrative of the principles, teachings and some example embodiments of this invention, and not in limitation thereof.

1. A method, comprising:
receiving one or more first buffer status report and one or more second buffer status report by an access point over a link from one or more user equipment in a dual connection deployment scenario in response to a cross link buffer status report trigger.

2. The method of claim 1, wherein the first buffer status report is a local area buffer status report, the second buffer status report is a macro buffer status report and the link is a macro link and the access point is a macro base station.

3. The method of claim 1, wherein the first buffer status report is a local area buffer status report, the second buffer status report is a macro buffer status report and the link is a local area link and the access point is a local area access point.

4. (canceled)

5. The method of claim 2, wherein the cross link buffer status report trigger comprises:
a radio link failure trigger adapted to indicate a radio link failure of the macro link or the local area link,
wherein, in response to an indication of a local area link failure, transmitting the local area buffer status report link buffer status report to the macro base station over the macro link or in response to an indication of a macro link failure, transmitting a macro buffer status report to a local area access point over the local area link,
wherein either the macro base station or local area access point selectively direct a user equipment to perform a radio resource control establishment procedure over an operation radio link.

6. The method of claim 4, wherein if the local area buffer status report indicates one or more of the plurality of logical channels or one or more logical channel groups is a high priority logic channel and the macro link has a low traffic load then the one or more high priority logical channels or one or more high priority logical channel groups are directed to the macro link.

7. The method of claim 6, wherein if the local area buffer status report indicates that the local area link has a low traffic load then the one or more high priority logical channels or one or more high priority logical channel groups are directed to stay on the local area link.

8. The method of claim 6, wherein if the local area buffer report indicates that data storage capacity corresponding to the plurality of high priority logical control channels or one or more high priority logical channel groups does not exceed a predetermined data storage threshold then the one or more high priority logical channels or one or more high priority logical channel groups are directed to the macro link.

9. (canceled)

10. The method of claim 2, wherein the cross link buffer status report trigger comprises:
receiving a buffer condition request from either the macro base station or the local area access point, said buffer condition request being adapted to direct the user equipment to report back the local area buffer status report and/or the macro buffer status report; and
transmitting the local area buffer status report and/or the macro buffer status report to either the macro base station or the local area access point.

11. The method of claim 10, further comprising the step of:
receiving an enable/disable cross link buffer status report trigger adapted to enable or disable the cross link buffer status trigger.

12. The method of claim 11, wherein the enable/disable cross link buffer status report is a radio resource control message or an uplink time division multiplexing pattern.

13-16. (canceled)

17. An apparatus, comprising:
circuitry adapted to cause the apparatus to at least:
receive one or more first buffer status report and one or more second buffer status report by an access point over a link from one or more user equipment in a dual connection deployment scenario in response to a cross link buffer status report trigger.

18. The apparatus of claim 17, wherein the first buffer status report is a local area buffer status report, the second buffer status report is a macro buffer status report and the link is a macro link and the access point is a macro base station.

19. The apparatus of claim 17, wherein the first buffer status report is a local area buffer status report, the second buffer status report is a macro buffer status report and the link is a local area link and the access point is a local area access point.

20. (canceled)

21. The apparatus of claim 18, wherein the cross link buffer status report trigger comprises:
a radio link failure trigger adapted to indicate a radio link failure of the macro link or the local area link,
wherein, in response to an indication of a local area link failure, transmitting the local area buffer status report link buffer status report to the macro base station over the macro link or in response to an indication of a macro link failure, transmitting a macro buffer status report to a local area access point over the local area link,
wherein either one or more components within the macro base station or local area access point selectively direct a user equipment to perform a radio resource control establishment procedure over an operation radio link.

22. The apparatus of claim 21, wherein the macro base station or local area access point selectively direct a user equipment to perform a radio resource control establishment procedure over an operation radio link.

23-34. (canceled)

35. A program storage device readable by a machine, tangibly embodying a program of instructions executable by the machine for causing performance of operations, said operations comprising:
receiving one or more first buffer status report and one or more second buffer status report by an access point over a link from one or more user equipment in a dual connection deployment scenario in response to a cross link buffer status report trigger.

36. The program storage device of claim 35, wherein the first buffer status report is a local area buffer status report, the second buffer status report is a macro buffer status report and the link is a macro link and the access point is a macro base station.

37. The program storage device of claim 35, wherein the second first status report is a local area buffer status report, the second buffer status report is a macro buffer status report and the link is a local area link and the access point is a local area access point.

38. (canceled)

39. The computer program device of claim 36, wherein the cross link buffer status report trigger comprises:
a radio link failure trigger adapted to indicate a radio link failure of the macro link or the local area link,
wherein, in response to an indication of a local area link failure, transmitting the local area buffer status report link buffer status report to the macro base station over the macro link or in response to an indication of a macro link failure, transmitting a macro buffer status report to a local area access point over the local area link,
wherein either the macro base station or local area access point selectively direct a user equipment to perform a radio resource control establishment procedure over an operation radio link.

40. The computer program device of claim 38, wherein if the local area buffer status report indicates one or more of the plurality of logical channels or one or more logical channel groups is a high priority logic channel and the macro link has a low traffic load then the one or more high priority logical channels or one or more high priority logical channel groups are directed to the macro link.

41-124. (canceled)
